(19) United States
(12) Patent Application Publication
(10) Pub. No.: US 2014/0176669 A1
(43) Pub. Date: Jun. 26, 2014

(54) IMAGE PROCESSING APPARATUS THAT COMBINES A PLURALITY OF IMAGES

(71) Applicant: CASIO COMPUTER CO., LTD., TOKYO (JP)

(72) Inventors: Kosuke MATSUMOTO, Tokyo (JP); Naotomo MIYAMOTO, Tokyo (JP)

(73) Assignee: CASIO COMPUTER CO., LTD., TOKYO (JP)

(21) Appl. No.: 14/134,805

(22) Filed: Dec. 19, 2013

(30) Foreign Application Priority Data
Dec. 21, 2012 (JP) 2012-280125

(51) Int. Cl. H04N 5/232

(52) U.S. Cl. CPC H04N 5/23238; H04N 5/23293; H04N 5/23245; H04N 5/23216
USPC 348/36

(57) ABSTRACT

An image capture apparatus (1) includes: an image capture unit (17) that successively acquires images; an image combining unit (91) that combines the acquired images in a predetermined range so as to generate a wide image; a display control unit (51) that controls a display to simultaneously display a live-view image and a predetermined range such that a relative size between the live-view image and the predetermined range is visible on the display; a view angle setting unit (53) that changes the relative size while the live-view image and the predetermined range are being displayed on the display; and an image combining control unit (92) that controls the combining unit so as to generate the wide image an angle of view of which depends on the changed relative size.

This application is based on and claims the benefit of priority from Japanese Patent Application No. 2012-280125, filed on 21 Dec. 2012, the content of which is incorporated herein by reference.

### BACKGROUND OF THE INVENTION

1. Field of the Invention

The present invention relates to an image processing apparatus that combines a plurality of images, an image processing method, and a recording medium.

2. Related Art

As conventional technology, Japanese Unexamined Patent Application, Publication No. H11-69293 describes technology for generating an image of a wider angle than a single time image capturing, by combining images consecutively captured.

### SUMMARY OF THE INVENTION

An apparatus according to a first aspect of the present application is image processing apparatus comprising: an acquisition unit that successively acquires images; a combining unit that combines the acquired images in a predetermined range so as to generate a wide image; a display control unit that controls a display to simultaneously display a live-view image and a predetermined range such that a relative size between the live-view image and the predetermined range is visible on the display; a change unit that changes the relative size while the live-view image and the predetermined range are being displayed on the display; and a control unit that controls the combining unit so as to generate the wide image an angle of view of which depends on the changed relative size. A method of acquiring images comprising the steps of: successively acquiring images; combining the acquired images in a predetermined range so as to generate a wide image; Controlling display controls a display to simultaneously display a live-view image and a predetermined range such that a relative size between the live-view image and the predetermined range is visible on the display; changing the relative size while the live-view image and the predetermined range are being displayed on the display; and controlling the combining so as to generate the wide image an angle of view of which depends on the changed relative size. A non-transitory storage medium encoded with a computer-readable program that enables a computer to execute functions as: an acquisition unit that successively acquires images; a combining unit that combines the acquired images in a predetermined range so as to generate a wide image; a display control unit that controls a display to simultaneously display a live-view image and a predetermined range such that a relative size between the live-view image and the predetermined range is visible on the display; a change unit that changes the relative size while the live-view image and the predetermined range are being displayed; and a combining control unit that controls the combining unit so as to generate the wide image an angle of view of which depends on the changed relative size.

### BRIEF DESCRIPTION OF THE DRAWINGS

FIG. 1A is a schematic diagram illustrating a digital wide image of the present embodiment;

FIG. 1B is a schematic diagram illustrating a digital wide image of the present embodiment;

FIG. 2 is a schematic diagram illustrating setting of a photographing mode and a setting method of a trimming area in a photographing mode;

FIG. 3 is a block diagram showing a configuration of hardware of an image capture apparatus according to an embodiment of the present invention;

FIG. 4 is a functional block diagram showing a functional configuration for executing view-angle setting processing, image capture processing and digital wide image generation processing, among the functional configurations of the image capture apparatus in FIG. 1;

FIG. 5 is a flowchart illustrating the flow of view-angle setting processing executed by the image capture apparatus in FIG. 3 having the functional configuration of FIG. 4;

FIG. 6 is a schematic diagram showing a specific example of view angle setting for a generated image of the present embodiment;

FIG. 7 is a flowchart showing the flow of image capture processing executed by the image capture apparatus in FIG. 3 having the functional configuration of FIG. 4; and

FIG. 8 is a flowchart showing the flow of digital wide image generation processing executed by the image capture apparatus in FIG. 3 having the functional configuration of FIG. 4.

### DETAILED DESCRIPTION OF THE INVENTION

In the following, embodiments of the present invention will be explained with reference to the drawings.

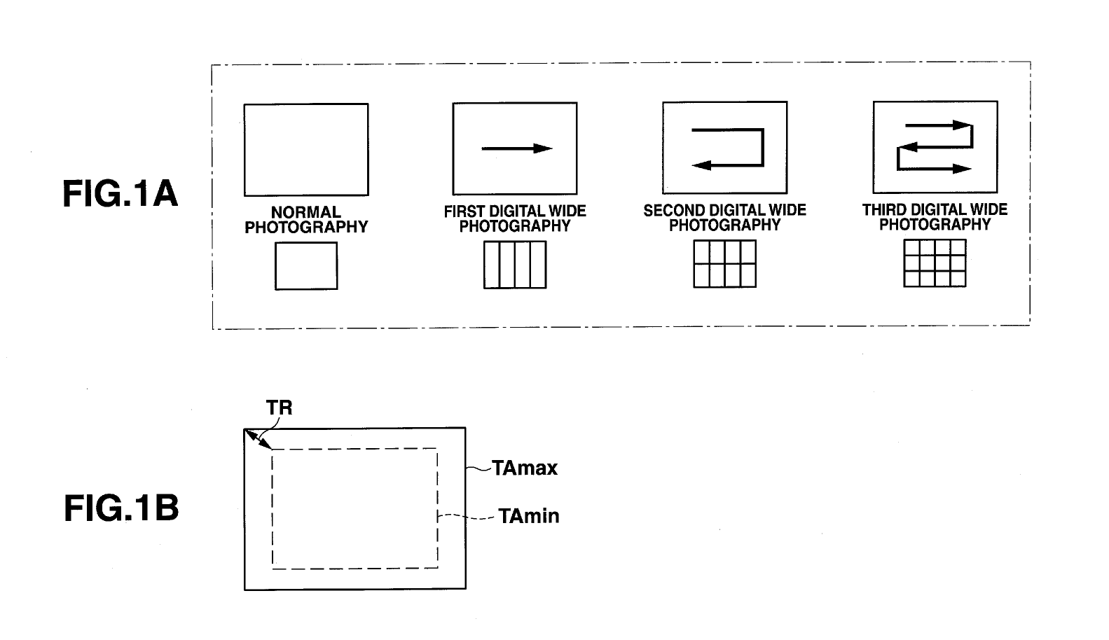

FIG. 1 is a schematic diagram illustrating a digital wide image of the present embodiment.

“Digital wide image” is an image with an aspect ratio identical to the aspect ratio (4:3) of normal images, and a wider angle image than normal images. In addition, “digital wide image” is an image generated by combining a plurality of images with different captured areas and digitally processing, without optical processing such as changing to a wide-angle lens.

In the present embodiment, it is possible to generate digital wide images in which view angles (width of combining range of images) respectively differ. In other words, by changing the number of images to be the targets for combining and the level of digital wide mode (described later), digital wide images in which view angles respectively differ can be generated.

In the present embodiment, in the case of generating a digital wide image, it is configured so as to change a cutout region (hereinafter referred to as “trimming area”) of an image used in the generation of the digital wide image.

In the present embodiment configured in this way, the changing of the photographing mode (described later), the changing of the trimming area (described later) under the level of a predetermined digital wide mode in the case of this photographing mode being a digital wide mode, and the setting of the view angle in the case of the photographing mode being a digital wide mode of a predetermined level, are performed by way of an operation on a live view image displayed on a display unit 20.

In the present embodiment, the four photographing modes of a normal photographing mode, first digital wide photographing mode (digital wide mode of level 1), second digital wide photographing mode (digital wide mode of level 2), third digital wide photographing mode (digital wide mode of level 3) are settable, as shown in FIG. 1A.

“Normal photographing mode” is a mode that photographs a subject at the normal view angle. In the “normal photographing mode”, for example, one image of a subject is photographed.

In addition, with the “normal photographing mode”, the trimming area is fixed. In other words, with the “normal photographing mode”, a change in the trimming area is not possible.

The “first digital wide photographing mode”, for example, is a mode that generates a digital wide image having the narrowest view angle among the three digital wide modes, and in the present embodiment, acquires a plurality of images by causing the image capture apparatus to move, and generates a digital wide image from the acquired images. In the present embodiment, the digital wide image generated according to the first digital wide photographing mode is constituted by four images; therefore, a plurality of images constituting the digital wide image is acquired by performing image capture processing four times every time causing the image capture apparatus 1 to move a predetermined distance in a direction to the right. A digital wide image having an aspect ratio of 4:3 is generated by combining the images photographed in this way according to the image capturing position.

In addition, with the “first digital wide photographing mode”, within the trimming range TR between a maximum trimming area TAmax and a minimum trimming area TAmin for the trimming area, it is possible to change the digital wide image to an arbitrary size by finely adjusting in this range, as shown in FIG. 1B.

The “second digital wide photographing mode”, for example, is a mode that generates a digital wide image in which the view angle of the digital wide image is a wider angle in the vertical direction than the aforementioned first digital wide photographing mode. In the present embodiment, for the digital wide image generated by the second digital wide photographing mode, image capture processing is performed four times every time causing the image capture apparatus 1 to move a predetermined distance in the right-side direction, and then image capture processing is performed four times every time causing the image capture apparatus 1 to move a predetermined distance in the direction to the left after having caused to move downwards. As a result, four images at the top and four images at the bottom are acquired. A digital wide image having an aspect ratio of 4:3 is generated by combining the images acquired in this way in response to the image capturing positions.

In addition, similarly to the “first digital wide photographing mode”, with the “second digital wide photographing mode”, within the trimming range TR between a maximum trimming area TAmax and a minimum trimming area TAmin for the trimming area, it is possible to arbitrarily change the size of the digital wide image generated to an by finely adjusting the trimming area.

The “third digital wide photographing mode”, for example, is a mode that generates a digital wide image in which the view angle of the digital wide image is even wider vertically than the aforementioned second digital wide photographing mode. In the present embodiment, the digital wide image generated according to the third digital wide photographing mode, image capture processing is performed four times every time causing the image capture apparatus 1 to move a predetermined distance in the direction to the right, and then image capture processing is performed four times every time causing the image capture apparatus 1 to move a predetermined distance in the direction to the left after having caused to move downwards, and further image capture is performed four times every time causing the image capture apparatus 1 to move a predetermined distance in the direction to the right after having caused to move downwards. As a result, four images at the top, four images in the middle, and four images at the bottom are photographed. A digital wide image having an aspect ratio of 4:3 is generated by combining the images photographed in this way in accordance with the image capturing positions.

In addition, similarly to the “first digital wide photographing mode”, with the “third digital wide photographing mode”, within the trimming range TR between a maximum trimming area TAmax and a minimum trimming area TAmin for the trimming area, it is possible to arbitrarily change the size of the digital wide image generated to an by finely adjusting the trimming area.

A method of setting of the present embodiment will be explained that enables setting the photographing mode, the range of trimming area in the case of the photographing mode being a predetermined digital wide mode, and a view angle in the digital wide mode of a predetermined level in this way.

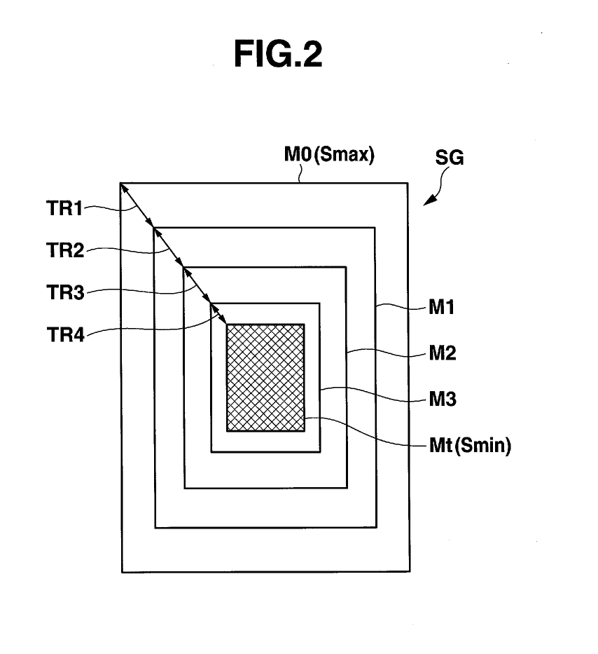

FIG. 2 is a schematic diagram illustrating the setting method of the photographing mode, range of trimming area in the case of the photographing mode being a predetermined digital wide mode, and the view angle in a digital wide mode of a predetermined level.

In the present embodiment, setting and changing of the photographing mode, range of trimming area in the case of the photographing mode being a digital wide mode, and the view angle of the digital wide mode in the case of the photographing mode being a digital wide mode is performed by one operation.

More specifically, as shown in FIG. 2, changing of the photographing mode, range of trimming area, and the view angle is performed by changing the size of the setting image SI displayed on a display means.

The “setting image SI” is an image displayed on a setting screen, and is an image serving as a sign when performing setting and changing of the photographing mode, range of the trimming area, and view angle of the digital wide image in the case of the photographing mode being a digital wide mode. By changing the size of this setting image SI, it is possible to select the photographing mode, range of the trimming area, and view angle of the digital wide image in the case of the photographing mode being a digital wide mode. In other words, the photographing mode, trimming area and view angle of the digital wide image come to be designated by the size of the setting image SI.

Information of the photograph mode, range of the trimming area and view angle are assign according to the size of the setting image SI, and by changing the size of the setting image SI so as to correspond to a desired setting, it is possible to set the photographing mode, trimming area and view angle of the digital wide image.

More specifically, in the present embodiment, as a default display for the display state of the setting image SI, the setting image SI is the maximum size Smax, and “normal photographing mode” is set at this position M0. It should be noted that the setting image SI is a live view image in the present embodiment.

“Live view image” refers to an image being sequentially output as a result of starting image capture operation by the image capture unit built into the image capture apparatus 1. This live view image is an image that is temporarily stored in a storage unit built into the image capture apparatus 1, and subsequently sequentially displayed on the display unit built into the image capture apparatus 1. As a result of displaying the live view image, the current photographing scene comes to be displayed moment by moment on the display unit of the image capture apparatus 1.

When the setting image SI is set to less than the size of the position M0 (herein, set to “position M1”), the “first digital wide photographing mode” is set. Furthermore, the trimming level under the “first digital wide photographing mode” is set at a position within the region TR2 between position M1 to position M2. As positioning from position M1 to position M2, it is possible to change the range of the trimming area from the minimum trimming area TAmin towards the maximum trimming area TAmax shown in FIG. 1B. In addition, the view angle of the digital wide image is set according to the size of the setting image SI at this time.

In addition, when the setting image SI is set to the size of the position M2, the “second digital wide photographing mode” is set. Furthermore, at a position within the region TR3 between position M2 and position M3, the trimming level is set under the “second digital wide photographing mode”. As positioning from position M2 to position M3, it is possible to change the range of the trimming area from the minimum trimming area TAmin towards the maximum trimming area TAmax shown in FIG. 1B. In addition, the view angle of the digital wide image is set according to the size of the setting image SI at this time.

Furthermore, when setting the setting image SI to the size of position M3, the “third digital wide photographing mode” is set. Furthermore, at a position within the region TR4 between position M3 and position Mt serving as a size Smin from which the size of the setting image SI cannot be decreased more, the trimming level is set under the “third digital wide photographing mode”. As positioning from position M3 to position Mt, it is possible to change the range of the trimming area from the minimum trimming area TAmin towards the maximum trimming area TAmax shown in FIG. 1B. In addition, the view angle of the digital wide image is set according to the size of the setting image SI at this time.

It should be noted that, in the case of making an operation from position Mt to position M0, the positional relationship setting the digital wide photographing mode will be opposite to the aforementioned setting.

By setting the photographing mode, trimming area and view angle of the digital wide image by operating so as to change the size of the setting image in this way, setting with an intuitive operation becomes possible. In addition, by making the range of the trimming area changeable within digital wide modes, it is possible to perform changing of the view angle of a digital wide image ultimately generated at the user's desired view angle, without the setting of the view angle being discrete.

In the following, a hardware configuration of the image capture apparatus 1 having the abovementioned functions will be explained with reference to the drawings.

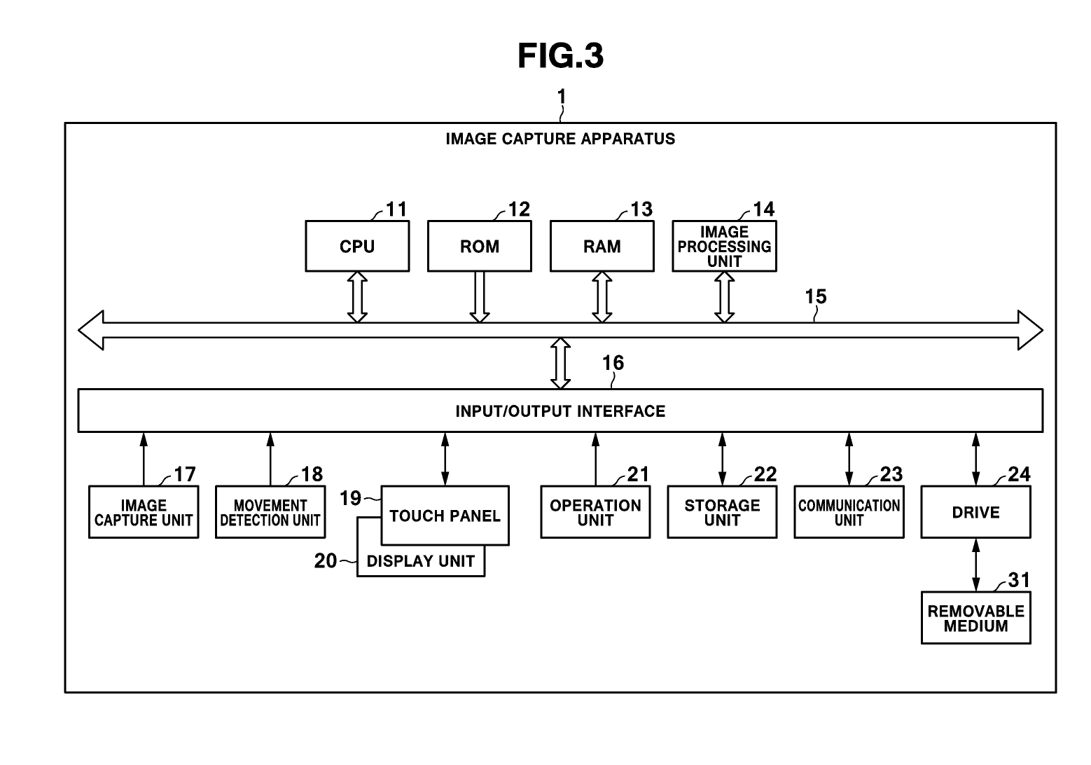

FIG. 3 is a block diagram showing a hardware configuration of the image capture apparatus 1 according to an embodiment of the present invention.

The image capture apparatus 1 is configured as, for example, a digital camera.

The image capture apparatus 1 includes a CPU (Central Processing Unit) 11, ROM (Read Only Memory) 12, RAM (Random Access Memory) 13, an image processing unit 14, a bus 15, an Input/Output interface 16, an image capture unit 17, an movement detection unit 18, a touch panel 19, a display unit 20, an operation unit 21, a storage unit 22, a communication unit 23, and a drive 24.

The CPU 11 executes various processing according to programs that are recorded in the ROM 12, or programs that are loaded from the storage unit 22 to the RAM 13.

The RAM 13 also stores data and the like necessary for the CPU 11 to execute the various processing, as appropriate.

The image processing unit 14 is configured with a DSP (Digital Signal Processor), VRAM (Video Random Access Memory), and the like, and cooperates with the CPU 11 to perform various image processing on data of images.

The CPU 11, the ROM 12, the RAM 13, and the image processing unit 14 are connected to one another via the bus 15. The input/output interface 16 is also connected to the bus 15. The image capture unit 17, the movement detection unit 18, the touch panel 19, the display unit 20, the operation unit 21, the storage unit 22, the communication unit 23, and the drive 24 are connected to the input/output interface 16.

The image capture unit 17 includes an optical lens unit and an image sensor, which are not illustrated.

In order to photograph a subject, the optical lens unit is configured by a lens such as a focus lens and a zoom lens for condensing light.

The focus lens is a lens for forming an image of a subject on the light receiving surface of the image sensor. The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capture unit 17. Such an output signal of the image capture unit 17 is hereinafter referred to as “image data”. The data of this image comes to be used as data of an original image used in the generation of a panoramic image.

The movement detection unit 18 is configured by a gyro sensor, for example, and detects velocity and angular velocity of the image capture apparatus 1.

Herein, the image capture apparatus 1 performs image capturing a plurality of times at predetermined intervals (interval at which distance of movement is fixed in present embodiment) in the middle of moving, as mentioned above. The detection results of the movement detection unit 18 are used in the calculation of this predetermined interval. In other words, the CPU 11 calculates a movement amount of the image capture apparatus 1 based on the detection results of the movement detection unit 18 (velocity and angular velocity), and performs image capturing a plurality of times at the predetermined interval depending on this movement amount.

The image capture apparatus 1 comes to acquire a plurality of images depending on the level of the mode of digital wide photographing, from the detection results of the movement detection unit 18.

The touch panel 19 enables the detection of touch operations of a user, and input various information depending on the touch operation of the user.

The display unit 20 is configured by a display, speaker, etc., and outputs images and sound.

The operation unit 21 is configured by various physical buttons such as a cross-shaped key and a shutter button, and inputs various information depending on the instruction operation of the user.

The storage unit 22 is configured by a hard disk or DRAM (Dynamic Random Access Memory) or the like, and stores data of various images.

The communication unit 23 controls communication with other devices (not shown) via networks including the Internet.

A removable medium 31 composed of a magnetic disk, an optical disk, a magneto-optical disk, semiconductor memory or the like is installed in the drive 24, as appropriate. Programs that are read via the drive 24 from the removable medium 31 are installed in the storage unit 22, as necessary. Similarly to the storage unit 22, the removable medium 31 can also store a variety of data such as the image data stored in the storage unit 22.

The configuration of hardware of the image capture apparatus 1 according to an embodiment of the present invention has been explained above.

Next, among the functional configurations of such an image capture apparatus 1, the functional configuration for executing view angle setting processing will be explained.

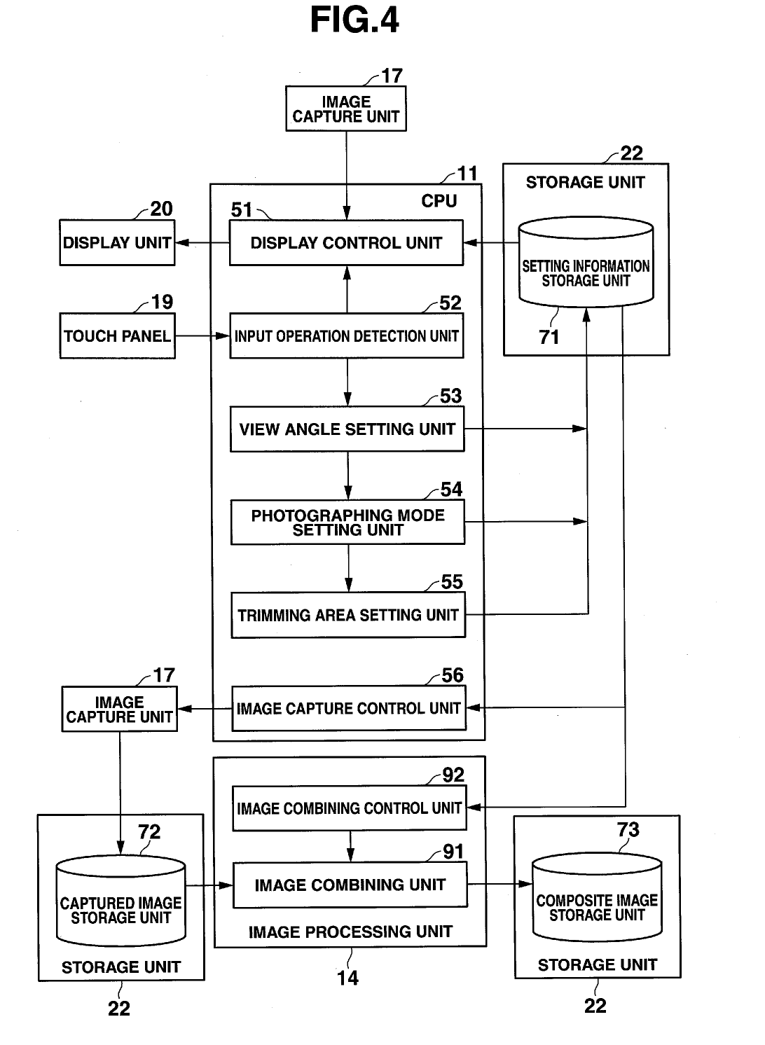

FIG. 4 is a functional block diagram showing a functional configuration for executing view angle setting processing, image capture processing, and digital wide image generation processing, among the functional configurations of such an image capture apparatus 1.

“View angle setting processing” performs a sequence of processing until setting the photographing mode, trimming area and view angle of the digital wide image, by changing the size of the setting image displayed on the setting screen. It should be noted that, in the present embodiment, it is configured so as to use the live view image as the setting image.

By establishing the live view image as the setting image, it is possible for the user to reference the photographing conditions, while setting the photographing mode and the view angle of the digital wide image matching these photographing conditions.

In the case of executing view angle setting processing, the display control unit 51, input operation detection unit 52, view angle setting unit 53, photographing mode setting unit 54 and trimming area setting unit 55 of the CPU 11 function in FIG. 4.

A setting information storage unit 71 is provided as an area of the storage unit 22.

Setting images serving as a guide for view angle setting, information for the corresponding relationship between the size of the setting image and the setting, the setting of the photographing mode, trimming area and view angle of the digital wide image which are results of the setting operation, etc. are stored in the setting information storage unit 71.

The display control unit 51 causes the setting image to be displayed upon display of the setting screen, and in the case of there having been an operation relating to a change in the size of the setting image by a user, controls the display unit 20 so as to cause the size of the setting image to be displayed to change in accordance with this operation.

The input operation detection unit 52 detects operations of the user on the touch panel 19. The input operation detection unit 52, for example, detects operations to set the view angle (hereinafter referred to as view angle setting operation“) such as an operation making two fingers approach so as to pinch in a state in which two fingers of the user contact the touch panel 19 (hereinafter also referred to as “pinch-in operation”), and conversely an operation to distance the two fingers (hereinafter also referred to as “pinch-out operation”).

The view angle setting unit 53 performs setting of the view angle of a digital wide image, based on the view angle setting operation, which is a detection result of the input operation detection unit 52. In addition, the view angle setting unit 53 causes the information of the view angle set to be stored in the setting information storage unit 71.

The photographing mode setting unit 54 sets the photographing mode corresponding to the view angle set by way of the view angle setting unit 53. In addition, the photographing mode setting unit 54 causes information of this photographing mode set to be stored in the setting information storage unit 71.

The trimming area setting unit 55 determines a trimming area corresponding to the view angle set by way of the view angle setting unit 53. In addition, the trimming area setting unit 55 causes information of this trimming area set to be stored in the setting information storage unit 71.

Among the functional configurations of the image capture apparatus 1 of FIG. 3, the functional configuration for executing view angle setting processing has been explained above.

Next, among the functional configurations of the image capture apparatus 1 of FIG. 3, the functional configuration for executing image capture processing will be explained.

“Image capture processing” is a sequence of processing performing photography of images in accordance with the settings of the photographing mode until acquiring an image conforming to this photographing mode.

In the case of executing image capture processing, the image capture control unit 56 functions in the CPU 11, as shown in FIG. 4.

An image storage unit 72 is provided in an area of the storage unit 22.

The image capture control unit 56 controls the image capture unit 17, based on information of the photographing mode stored in the setting information storage unit 71. Data of images is output from the image capture unit 17 to the image storage unit 72.

The data of images output from the image capture unit 17 is stored in the image storage unit 72.

Among the functional configurations of the image capture apparatus 1 of FIG. 3, the functional configuration for executing image capture processing has been explained above.

Next, among the functional configurations of the image capture apparatus 1 of FIG. 3, the functional configuration for executing digital wide image generation processing will be explained.

“Digital wide image generation processing” is a sequence of processing the generates a composite image to be the same aspect ratio as the image from the plurality of acquired images, until generating a digital wide image arrived by cutting out a desired region at the same aspect ratio as the image from the generated composite image.

In the case of executing digital wide image generation processing, an image combining unit 91 and image combining control unit 92 function in the image processing unit 14, as shown in FIG. 4.

The image combining unit 91 generates data of a composite image by combining the data of images stored in the image storage unit 72. The image combining unit 91 causes the data of a generated composite image to be stored by outputting to a composite image storage unit 73.

The image combining control unit 92 controls the image combining unit 91 so as to perform image combining of the data of images stored in the image storage unit 72, based on information of the photographing mode and information of the trimming area stored in the setting information storage unit 71.

The composite image storage unit 73 stores the data of composite images generated by the image combining unit 91.

Among the functional configurations of the image capture apparatus 1 of FIG. 3, the functional configuration for executing digital wide image generation processing has been explained above.

Next, processing related to the generation of a digital wide image performed by the image capture apparatus 1 of the present embodiment will be explained.

“Processing related to generation of digital wide image” is configured from view angle setting processing to set the view angle of the digital wide image, image capture processing to acquire a plurality of images in accordance with the photographing mode set in this view angle setting processing, and digital wide image generation processing to generate a composite image by combining this plurality of images acquired, and generate a digital wide image by cutting out the trimming area set in the view angle setting processing.

First, among the processing related to generation of a digital wide image, the flow of view angle setting processing will be explained.

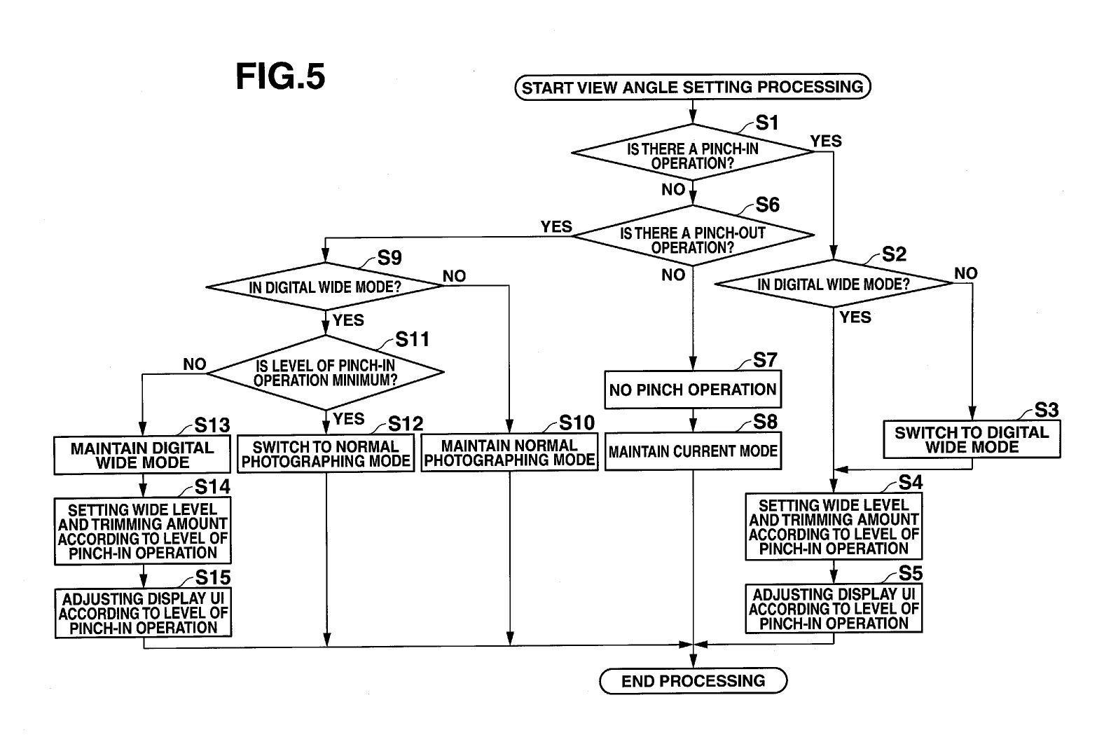

FIG. 5 is a flowchart illustrating the flow of view angle setting processing executed by the image capture apparatus 1 in FIG. 3 having the functional configuration of FIG. 4.

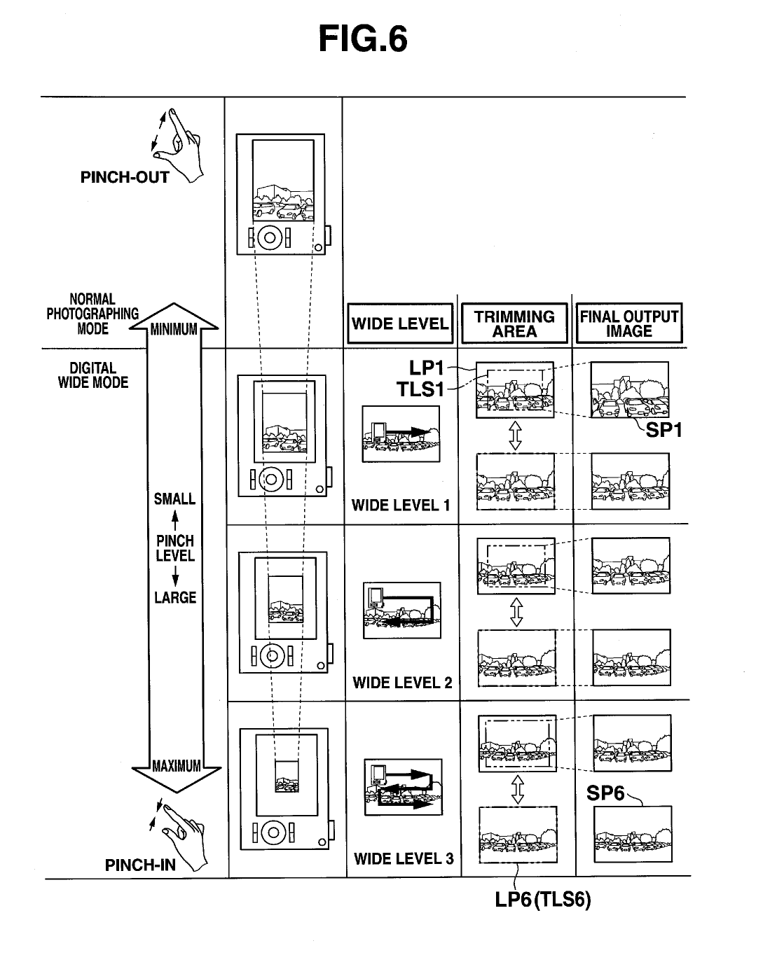

In addition, FIG. 6 is a schematic view showing a specific example of view angle setting of a generated image in the present embodiment.

It should be noted that, in FIG. 6, the setting image SI0 indicates a setting image in “normal photographing mode”, the setting image SI1 indicates a setting image in “wide level 1” of the “digital wide mode”, the setting image SI2 indicates a setting image in “wide level 2” of the “digital wide mode”, and the setting image SI3 indicates a setting image in “wide level 3” of the “digital wide mode”.

The view angle setting processing is initiated by an operation being made by the user to the touch panel 19.

When view angle setting processing is initiated, the display control unit 51 of the present embodiment performs control to cause the live view image acquired from the image capture unit 17 to be displayed on the display unit 20 as a setting image. The setting screen of a setting image such as that shown in FIG. 6 thereby comes to be displayed as the live view image.

In Step S1, the input operation detection unit 52 determines whether a pinch-in operation has been performed.

In the case of having determined that a pinch-in operation has been performed, it is determined as YES in Step S1, and the processing advances to Step S2.

In contrast, in the case of having determined that a pinch-in operation has not been performed, it is determined as NO in Step S1, and the processing advances to Step S6. The processing of Steps S6 and higher will be described later.

In Step S2, the photographing mode setting unit 54 determines whether the current photographing mode is a digital wide photographing mode.

In the case of the current photographing mode being a digital wide photographing mode, it is determined as YES in Step S2, and the processing advances to Step S3.

In Step S3, the photographing mode setting unit 54 switches the photographing mode to a digital wide photographing mode that is not the normal photographing mode.

In contrast, in the case of the current photographing mode not being a digital wide photographing mode, it is determined as NO in Step S2, and the processing advances to Step S4.

In Step S4, the view angle setting unit 53 sets the view angle of the digital wide photographing mode, according to the amount of pinch-in operation determined by the input operation detection unit 52.

In addition, in Step S4, the photographing mode setting unit 54 sets the level of the digital wide photographing mode, according to the view angle set by way of the view angle setting unit 53.

Furthermore, in Step S4, the trimming area setting unit 55 sets in response to the view angle set by way of the view angle setting unit 53.

In Step S5, the display control unit 51 controls the display unit 20 so as to change the image size of the setting image SI, according to the amount of pinch-in operation detected by the input operation detection unit 52.

In the example of FIG. 6, the default state is “normal photographing mode” at the image size of the setting image SI0, and by a user making a pinch-in operation to move from this state, the view angle of the digital wide image changes. In addition, by way of the pinch-in operation, it becomes the “wide level 1” of the “digital wide mode” at the image size of the setting image SI1, becomes the “wide level 2” of the “digital wide mode” at the image size of the setting image SI2, and changes to the “wide level 3” of the “digital wide mode” at the image size of the setting image SI3.

In addition, the trimming area setting unit 55 performs a decision of the trimming area in the “wide level 1” of the “digital wide mode” at an image size between the setting image SI1 and the setting image SI2, and performs a decision of the trimming area in the “wide level 2” of the “digital wide mode” at an image size between the setting image SI2 and the setting image SI3, and performs a decision of the trimming area in the “wide level 3” of the digital wide mode” between the setting image SI3 and a predetermined image size.

In other words, in the case of the level of the digital wide image mode being “1”, the photographing method of “wide level 1” is set, and the trimming area is set by the amount of the corresponding pinch-in operation. For example, in the case of the amount of the pinch-in operation being the minimum in the first digital wide image mode, the image is trimmed at the trimming frame TF1 shown in the top image LP1 of the “trimming area”, and the image of the digital wide image generated thereby becomes the top image SP1 of the “final output image”. The image SP1 is an image in which the wide-angle extent is the narrowest among the digital wide photographing modes.

In contrast, in the case of the level of the digital wide image mode being “3”, the photographing method of “wide level 3” is set, and the trimming area is set by the amount of the corresponding pinch-in operation. For example, in the case of the amount of pinch-in being the maximum in the digital wide image mode (level 3), the image comes to be trimmed at the trimming frame TF6 shown at the bottom image LP6 in the “trimming area”, and the image of the digital wide image generated thereby becomes the top image SP6 of the “final output image”. The image SP6 is an image having a wide-angle extent that is the widest among the digital wide photographing modes. By configuring in this way, it is possible for a user to generate a digital wide image with any wide-angle extent.

The view angle setting processing thereby ends.

In Step S6, the input operation detection unit 52 detects whether a pinch-out operation has been performed.

In the case of having determined that a pinch-out operation has not been performed, it is determined as NO in Step S6, and the processing advances to Step S7.

In contrast, in the case of a pinch-out operation having been performed, it is determined as YES in Step S6, and the processing advances to Step S9. The processing of Steps S9 and higher will be described later.

In Step S7, the input operation detection unit 52 determines that there is no pinch operation in itself, due to not detecting a pinch-in operation in Step S1, and then not detecting a pinch-out operation in Step S6.

In Step S8, the photographing mode setting unit 54 maintains the photographing mode in the mode currently set. In other words, the photographing mode setting unit 54 finishes view angle setting processing, without causing the information of the view angle setting to be stored in the setting information storage unit 71.

In Step S9, the photographing mode setting unit 54 determines whether the current photographing mode is a digital wide photographing mode.

In the case of the current photographing mode not being a digital wide photographing mode, it is determined as NO in Step S9, and the processing advances to Step S10.

In Step S10, the photographing mode setting unit 54 maintains the photographing mode in the normal photographing mode. In other words, the photographing mode setting unit 54 finishes view angle setting processing, without causing information of the view angle setting to be stored in the setting information storage unit 71.

In contrast, in the case of the current photographing mode being a digital wide photographing mode, it is determined as YES in Step S9, and the processing advances to Step S11.

In Step S11, the input operation detection unit 52 determines whether the level of the pinch-in operation is the minimum.

In the case of the level of the pinch-in operation being the minimum, it is determined as YES in Step S11, and the processing advances to Step S12.

In Step S12, the photographing mode setting unit 54 switches the photographing mode to the normal photographing mode, which is not a digital wide photographing mode.

In contrast, in the case of the level of the pinch-in operation not being the minimum, it is determined as NO in Step S11, and the processing advances to Step S13.

In Step S13, the photographing mode setting unit 54 maintains the photographing mode in the digital wide photographing mode.

In Step S14, the view angle setting unit 53 sets the view angle of the digital wide image according to the amount of the pinch-in operation determined by the input operation detection unit 52, the photographing mode setting unit 54 sets the level of the digital wide photographing mode in combining of the digital wide image, and the trimming area setting unit 55 sets the trimming area of the view angle of the digital wide image.

In detail, the view angle setting unit 53 performs setting of the view angle of the digital wide image corresponding to the detection result of the input operation detection unit 52 having detected a pinch operation on the touch panel 19 by the user, and causes information of the view angle set to be stored in the setting information storage unit 71.

Furthermore, in detail, the photographing mode setting unit 54 sets the photographing mode corresponding to the view angle of the digital wide image set, and causes information of this photographing mode set to be stored in the setting information storage unit 71.

Moreover, in detail, the trimming area setting unit 55 determines the trimming area corresponding to the view angle of the digital wide image set, and causes information of the trimming area determined to be stored in the setting information storage unit 71.

In Step S15, the display control unit 51 controls the display unit 20 so as to change the image size of the setting image, according to the amount of the pinch-in operation detected by the input operation detection unit 52.

The view angle setting processing thereby ends.

Next, among the processing related to the generation of a digital wide image, the flow of image capture processing will be explained.

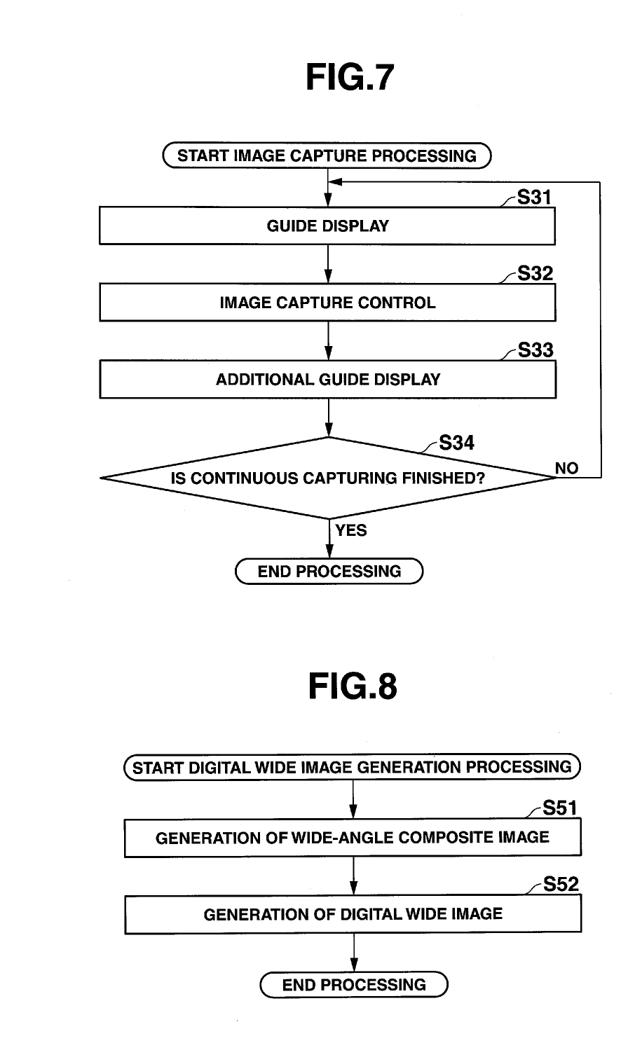

FIG. 7 is a flowchart showing the flow of image capture processing executed by the image capture apparatus 1 in FIG. 3 having the functional configuration of FIG. 4.

Image capture processing is initiated by an operation being made by the user to the touch panel 19.

In addition, after the image capture processing has been initiated, AF processing is performed by half-press operating the operation unit 21 such as the shutter button, and subsequently, image capture is initiated by making fully pressing.

In Step S31, the display control unit 51 controls the display unit 20 so as to perform guide display corresponding to the photographing mode set in view angle setting processing. For example, guide display prompting to move the image capture apparatus 1 so as to perform image capture in a photographing order such as that shown in FIG. 1A is made on the display unit 20. In the case of the required images having been acquired, the acquired images are added and addition guide display is performed on this guide display. The user can known how a plurality of images required should be acquired by moving the image capture apparatus 1 in which direction by how much, while looking at the addition display.

In Step S32, the image capture control unit 56 controls the image capture unit 17 to sequentially acquire data of images, based on the information of the photographing mode stored in the setting information storage unit 71. Subsequently, the data of images acquired is stored in the image storage unit 72.

In Step S33, the display control unit 51 controls the display unit 20 so as to add the acquired images to the guide display.

In Step S34, the CPU 11 determines whether continuous capturing has finished.

In the case of continuous capturing not having ended, it is determined as NO in Step S34, the processing returns to Step S31 to perform acquisition of images.

In contrast, in the case of continuous capturing ending, it is determined as YES in Step S34, and image capture processing ends.

Next, among the processing related to the generation of a digital wide image, the flow of digital wide image generation processing will be explained.

FIG. 8 is a flowchart showing the flow of digital wide image generation processing executed by the image capture apparatus 1 in FIG. 3 having the functional configuration of FIG. 4.

Digital wide image processing is initiated by an operation being made by the user on the touch panel 19.

In Step S51, the image combining control unit 92 controls the image combining unit 91 so as to combine a plurality of images acquired from the storage unit 22 in a predetermined image capture order corresponding to the photographing mode set by the view angle setting processing, and generate data of a composite image of the same aspect ratio as the aspect ratio (4:3) of the image.

In Step S52, the image combining control unit 92 controls the image combining unit 91 so as to generate data of a digital wide image of a desired size set by the user, by cutting out, from the composite image generated, an image so as to be the trimming area that is the same aspect ratio as the aspect ratio (4:3) of the image set by the view angle setting processing.

Subsequently, the image combining unit 91 outputs the data of the digital wide image generated and causes to be stored in the composite image storage unit 73. The digital wide image processing thereby ends.

Therefore, in the image capture apparatus 1, it is possible to provide a digital wide image of any size, due to generating, from the composite image, a digital wide image from a trimming area, which is a region of any size making the same ratio as the aspect ratio of the image.

In addition, in the image capture apparatus 1, due to generating a digital wide image from a plurality of images by cutting out, from a composite image that is a range including the predetermined range and forms the same ratio as the aspect ratio of the image, a part of the composite image, it is possible to prevent a resolution decline, and a high-quality digital wide image can be provided.

In the present embodiment, a predetermined number of images is made to be photographed by a photographing technique such as that shown in FIG. 1A, according to the photographing mode set as described above.

Then, the plurality of images acquired is image combined in the arrangement of the photographing mode to generate a digital wide image, and an image is cut out in the trimming area set as shown in FIG. 1B to generate a digital wide image forming a desired view angle.

The image capture apparatus 1 configured in the above way includes the image capture unit 17, image combining unit 91, display control unit 51, view angle setting unit 53, and image combining control unit 92.

The image capture unit 17 successively acquires images.

The image combining unit 91 combines the acquired images in a predetermined range so as to generate a wide image.

The display control unit 51 controls a display to simultaneously display a live-view image and a predetermined range such that a relative size between the live-view image and the predetermined range is visible on the display.

The view angle setting unit 53 changes the relative size while the live-view image and the predetermined range are being displayed on the display.

The image combining control unit 92 controls the combining unit so as to generate the wide image an angle of view of which depends on the changed relative size.

For this reason, in the image capture apparatus 1, the display mode of the relative size of the successively acquired images relative to the predetermined range is changed in a state in which the relative sizes between the successively acquired images and the predetermined range is visible, and a composite image is generated according to the relative size changed.

Therefore, in the image capture apparatus 1, it is possible to combine a plurality of images with the desired composite range for the user.

The display control unit 51 controls the display to primarily display the live-view image a size of which substantially matches with a size of the predetermined range.

The view angle setting unit 53 changes the relative size so that the size of the live-view image shrink relative to the predetermined range.

The image combining control unit 92 controls the image combining unit 91 to generate the wide image the size of which depends on a degree of shrinkage of the live-view image.

For this reason, in the image capture apparatus 1, the display mode of the relative size is changed so that the successively acquired images shrink relative to the predetermined range, and a composite image is generated according to the relative size changed.

Therefore, in the image capture apparatus 1, it is possible to combine a plurality of images at the desired composite range for the user.

The display control unit 51 displays a predetermined frame surrounding the successively acquired images, as a predetermined range.

The view angle setting unit 53 changes the relative size between the live-view image and the predetermined frame.

For this reason, in the image capture apparatus 1, the predetermined setting frame surrounding the successively acquired images is displayed as a predetermined range, along with the relative size between the acquired images and the predetermined setting frame changing.

Therefore, in the image capture apparatus 1, it is possible to combine a plurality of images in the desired composite range for the user.

The view angle setting unit 53 changes relative size between the live-view image and the predetermined frame, by changing the size of the live-view image.

Therefore, the image capture apparatus 1 can combine a plurality of images in the desired composite range for the user.

The view angle setting unit 53 changes the relative size between the live-view image and the predetermined frame, by changing the size of the predetermined frame.

Therefore, the image capture apparatus 1 can combine an image in the desired composite range for the user.

The display of the display unit 20 has the touch panel 19.

The view angle setting unit 53 changes the relative size according to an operation on the touch panel 19.

Therefore, the image capture apparatus 1 allows a user to perform an intuitive operation, and thus can give a seamless impression.

In addition, the image capture apparatus 1 includes the trimming area setting unit 55 to trims an image combined by the image combining unit 91 to a predetermined size.

The view angle setting unit 53 sets the size of the image trimmed by the trimming area setting unit 55, based on the relative size of the image changed.

Therefore, the image capture apparatus 1 can combine an image in the desired composite range of the user.

It should be noted that the present invention is not to be limited to the aforementioned embodiment, and that modifications, improvements, etc. within a scope that can achieve the object of the present invention are included in the present invention.

In the aforementioned embodiment, it is configured so as to perform a change in the size of the setting image, i.e. change in settings, by operating the touch panel 19, which is stacked on the display unit 20; however, it is not limited thereto. For example, in place of the touch panel 19, it may be configured so as to change the size of the setting image by a physical operation button (operation unit 21) such as a cross-shaped key provided to the apparatus.

In addition, in the aforementioned embodiment, a live view image is used as the setting image; however, it is not limited thereto. The setting image may employ an image stored in advance, for example, as the setting image, so long as being an image to perform setting of the photographing mode and trimming area. In this case, although it may be configured so as to display one image, it may be configured so as to display by changing to an image for which the fact that the photographing mode has switched can be recognized (for example, an image for which each of the photographing modes is being displayed within the image), if becoming an image size for a photographing mode switch or the like.

In addition, in the aforementioned embodiment, it is configured so as to perform a change in the view angle of the digital wide image, by causing the size of the setting image displayed on the display unit 20 to change; however, it is not limited thereto. For example, it may be configured so as to provide a setting frame forming a sign of the setting of the view angle of the digital wide image (composite range of image) on the setting image, and perform a change in the view angle of the digital wide image by changing the size of this setting frame.

More specifically, the setting of the view angle (composite range of image) of the digital wide image may be performed by setting the size of the setting frame within the display unit 20 expressing the view angle (composite range of the image) of the digital wide image, by making a pinch-in or pinch-out operation through the touch panel 19 on the setting frame of the display region in the display unit 20 of the digital camera shown in FIG. 6.

In other words, although setting of the view angle of the digital wide image was established to be performed on the aforementioned setting image (live view image), the present invention is not limited thereto, and the object of the present invention can be achieved so long as able to set the view angle of the digital wide image by setting the relative sizes between the setting image and setting frame.

In addition, although setting of the photographing mode and trimming was done based on the view angle (composite range of image) of the digital wide image set by the view angle setting unit 53, it is not limited thereto.

In other words, the view angle setting unit 53 may be configured so as to perform setting of the view angle, based on the level of the photographing mode set by the photographing mode setting unit 54, and the trimming area in the photographing mode set by the trimming area setting unit 55.

It should be noted that it may be configured so as to allow operation by fixing the size of the setting frame within the display unit 20 expressing the view angle (composite range of the image) of the digital wide image, and then making the setting image changeable and setting, as well as to fix the setting image and to allow changing of the relative size of the setting frame, by making a pinch-in or pinch-out operation through the touch panel 19.

In addition, concerning the change in display of the setting image, for example, in the case of the setting image having become a size at a position at which the mode switches, it may be configured so as to perform display to notify of a change in the mode such as highlighting the periphery of the image, or changing so that the change in image delays temporarily.

In addition, it may be configured so as to cause the image of the setting results to be displayed on the screen in the size of the current setting image.

Furthermore, although the aforementioned embodiment is configured so as to perform a level-up in the digital wide photographing mode and enlargement of the trimming area in a photographing mode by performing an operation to make the setting image smaller, with a state in which the display of the setting image is the maximum set as an initial state of the setting screen, it is not limited thereto, and by setting a state in which the display of the setting image is a minimum as the initial state of the setting screen, it may be configured so as to perform a level-up in the digital wide photographing mode and enlargement of the trimming area in a photographing mode by an operation so as to enlarge the display range of the setting image.

In addition, with a state in which the display of the setting image, which is a live view image, is a maximum as the initial state of the setting screen, a switch from the normal photographing mode to a digital wide photographing mode is made by performing an operation to make this setting image smaller in the aforementioned embodiment; however, a technique of switching of such photographing modes will effective in scenes and the like in which it is desired to instantaneously change the photographing modes while watching the change in photography environment.

In other words, even if there is only one type of digital wide photographing mode, a technique such as performing an operation to make the setting image smaller with a state in which the display of the setting image, which is a live view image, is a maximum as the initial state of the setting screen, is effective as a technique of switching from the normal photographing mode to a wide-angle photographing mode (digital wide photographing mode).

In addition, although the aforementioned embodiment is configured so as to linearly move the image capture apparatus 1 and continuously acquire images in digital wide photographing, it is not limited thereto, and may be configured so as to acquire the necessary images when arriving at a desired photographable position, without relating the images required corresponding to the photographing mode to a specific photographing order.

In the aforementioned embodiments, a digital camera has been described as an example of the image capture apparatus 1 to which the present invention is applied; however, the present invention is not particularly limited thereto.

For example, the present invention can be applied to any electronic device in general having a view angle setting function. More specifically, for example, the present invention can be applied to a lap-top personal computer, a printer, a television, a video camera, a smart phone, an image processing apparatus, a portable navigation device, a cell phone device, a portable gaming device, and the like.

The processing sequence described above can be executed by hardware, and can also be executed by software.

In other words, the hardware configuration shown in FIG. 4 is merely an illustrative example, and the present invention is not particularly limited thereto. More specifically, the types of functional blocks employed to realize the above-described functions are not particularly limited to the example shown in FIG. 3, so long as the image capture apparatus 1 can be provided with the functions enabling the aforementioned processing sequence to be executed in its entirety.

A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 shown in FIG. 3 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), or the like. The magnetic optical disk is composed of an MD (Mini-Disk) or the like. The storage medium supplied to the user in a state incorporated in the device main body in advance may include, for example, the ROM 12 shown in FIG. 3, a hard disk included in the storage unit 22 shown in FIG. 3 or the like, in which the program is recorded.

It should be noted that, in the present specification, the steps describing the program recorded in the storage medium include not only the processing executed in a time series following this order, but also processing executed in parallel or individually, which is not necessarily executed in a time series.

Although some embodiments of the present invention have been described above, the embodiments are merely exemplifications, and do not limit the technical scope of the present invention. Various other embodiments can be employed for the present invention, and various modifications such as omission and replacement are possible without departing from the spirit of the present invention. Such embodiments and modifications are included in the scope of the invention and the summary described in the present specification, and are included in the invention recited in the claims as well as the equivalent scope thereof.

1. An image processing apparatus comprising:
an acquisition unit that successively acquires images;
a combining unit that combines the acquired images in a predetermined range so as to generate a wide image;
a display control unit that controls a display to simultaneously display a live-view image and a predetermined range such that a relative size between the live-view image and the predetermined range is visible on the display;
a change unit that changes the relative size while the live-view image and the predetermined range are being displayed on the display; and
a control unit that controls the combining unit so as to generate the wide image an angle of view of which depends on the changed relative size.

2. The image processing apparatus according to claim 1, wherein
the display control unit controls the display to primarily display the live-view image a size of which substantially matches with a size of the predetermined range,
the change unit changes the relative size so that the size of the live-view image shrink relative to the predetermined range, and
the control, unit controls the combining unit to generate the wide image the size of which depends on a degree of shrinkage of the live-view image.

3. The image processing apparatus according to claim 1, further comprising
a setting unit that sets a photographing mode in accordance with the relative size,
wherein the setting unit sets a normal photographing mode when a size of the live-view image and a size of the predetermined range substantially matches, and sets a digital wide mode when the size of the live-view image is relatively smaller than the size of the predetermined range.

4. The image processing apparatus according to claim 3, wherein the setting unit sets, from among a plurality of levels for the digital wide mode, a specific level according to the relative size, when the size of the live-view image is relatively smaller than the size of the predetermined range.

5. The image processing apparatus according to claim 1,
wherein the display control unit displays a predetermined frame surrounding the images successively acquired as the predetermined range, and
wherein the change unit changes the relative size between the live-view image and the predetermined frame.

6. The image processing apparatus according to claim 3, wherein the change unit changes the relative size between the live-view image and the predetermined frame, by changing the size of the live-view image.

7. The image processing apparatus according to claim 3, wherein the change unit changes the relative size between the live-view image and the predetermined frame, by changing the size of the predetermined frame.

8. The image processing apparatus according to claim 1,
wherein the display includes a touch panel, and
wherein the change unit changes the relative size according to an operation made on the touch panel.

9. The image processing apparatus according to claim 1, further comprising a ‘trimming unit that trims an image combined by the combining unit to a predetermined size,
wherein the change unit sets a size of an image trimmed by the trimming unit, based on the relative size of the image changed.

10. The image processing apparatus according to claim 1, further comprising an image capture unit that continuously captures images of a subject, and successively outputs images,
wherein the acquisition unit acquires the images successively output by the image capture unit.

11. A method of acquiring images comprising the steps of:
successively acquiring images;
combining the acquired images in a predetermined range so as to generate a wide image;
controlling display controls a display to simultaneously display a live-view image and a predetermined range such that a relative size between the live-view image and the predetermined range is visible on the display;
changing the relative size while the live-view image and the predetermined range are being displayed on the display; and
controlling the combining so as to generate the wide image an angle of view of which depends on the changed relative size.

12. A non-transitory storage medium encoded with a computer-readable program that enables a computer to execute functions as:
an acquisition unit that successively acquires images;
a combining unit that combines the acquired images in a predetermined range so as to generate a wide image;
a display control unit that controls a display to simultaneously display a live-view image and a predetermined range such that a relative size between the live-view image and the predetermined range is visible on the display;
a change unit that changes the relative size while the live-view image and the predetermined range are being displayed; and
a combining control unit that controls the combining unit so as to generate the wide image an angle of view of which depends on the changed relative size.

13. The image processing apparatus according to claim 2, further comprising an image capture unit that continuously captures images of a subject, and successively outputs images,
wherein the acquisition unit acquires the images successively output by the image capture unit.

14. The image processing apparatus according to claim 3, further comprising an image capture unit that continuously captures images of a subject, and successively outputs images,
wherein the acquisition unit acquires the images successively output by the image capture unit.

15. The image processing apparatus according to claim 4, further comprising an image capture unit that continuously captures images of a subject, and successively outputs images,
wherein the acquisition unit acquires the images successively output by the image capture unit.

16. The image processing apparatus according to claim 5, further comprising an image capture unit that continuously captures images of a subject, and successively outputs images,
wherein the acquisition unit acquires the images successively output by the image capture unit.

17. The image processing apparatus according to claim 6, further comprising an image capture unit that continuously captures images of a subject, and successively outputs images,
wherein the acquisition unit acquires the images successively output by the image capture unit.

18. The image processing apparatus according to claim 7, further comprising an image capture unit that continuously captures images of a subject, and successively outputs images,
wherein the acquisition unit acquires the images successively output by the image capture unit.

19. The image processing apparatus according to claim 8, further comprising an image capture unit that continuously captures images of a subject, and successively outputs images,
wherein the acquisition unit acquires the images successively output by the image capture unit.

20. The image processing apparatus according to claim 9, further comprising an image capture unit that continuously captures images of a subject, and successively outputs images,
wherein the acquisition unit acquires the images successively output by the image capture unit.
